(19) United States
(12) Patent Application Publication
(10) Pub. No.: US 2025/0322482 A1
(43) Pub. Date: Oct. 16, 2025

(54) LOW LATENCY VIDEO PASSTHROUGH PIPELINE

(71) Applicant: SAMSUNG ELECTRONICS CO., LTD., Gyeonggi-Do (KR)

(72) Inventors: Pravin Rao, San Jose, CA (US); Neeraj Parik, Los Gatos, CA (US); SreeRaman Anantharaman, Los Altos, CA (US)

(21) Appl. No.: 18/948,211

(22) Filed: Nov. 14, 2024

Related U.S. Application Data
(60) Provisional application No. 63/632,780, filed on Apr. 11, 2024.

(51) Int. Cl. G06T 1/20; G06T 1/60

(52) U.S. Cl. CPC G06T 1/20; G06T 1/60

(57) ABSTRACT

A system includes a Visual See-Through (VST) pipeline circuit capable of processing image data. The VST pipeline circuit is embodied as a die. The VST pipeline circuit includes an Image Signal Processing (ISP) circuit and a Display Processing Unit (DPU) circuit coupled to the ISP circuit. The VST pipeline circuit includes a memory circuit coupled to the ISP circuit and to the DPU circuit. The memory circuit is configured to implement a plurality of buffers that facilitate low latency operation of the ISP circuit and the DPU circuit.

### CROSS-REFERENCE TO RELATED APPLICATIONS

This application claims the benefit of U.S. Application No. 63/632,780 filed on Apr. 11, 2024, which is fully incorporated herein by reference.

### TECHNICAL FIELD

This disclosure relates to integrated circuits (ICs) and, more particularly, to video processing circuit architectures for use in ICs including System-on-Chip(s).

### BACKGROUND

Visual See-Through (VST) is a technology used in a variety of different types of electronic devices. VST technology allows a user to see the real-world as captured by one or more cameras of a VST device and rendered on one or more displays of the VST device. The real-world scenes may be displayed on the display(s) of the VST device with one or more digital content items overlayed on the real-world view as presented on the display(s). The digital content items that are overlayed on the real-world views may include text, graphics, a user interface, or other digital content.

VST latency is a significant factor in providing a useful and satisfying AR and/or MR experience to users. VST latency refers to the time delay between an occurrence of an event in the real-world and a time that the event is displayed or rendered on the display(s) of the VST device. In other words, VST latency measures the time required for camera(s) and/or image sensor(s) of the VST device to capture image data, e.g., video, of the real-world, perform any processing on the captured image data, and render the processed image data specifying the real-world view on the display(s). In order for the VST device to provide what feels to the user as real-time operation and to avoid inducing user discomfort such as motion sickness, VST latency should be kept as low as possible.

In this regard, too much VST latency may cause any number of problems that disrupt use of the VST device. Too much VST latency, for example, may cause degradation to the sense of immersion and/or presence of the user in the certain Augmented Reality (AR) and/or Mixed Reality (MR) experiences implemented using the VST device. A break in presence makes the AR/MR experience feel less realistic and less natural to the user. This can make the technology difficult and possibly disorienting for the user to use as even small amounts of VST latency result in a noticeable lag between the user's movements in the real-world and corresponding changes in the real-world view as displayed on the VST device.

VST latency may also cause reduced accuracy in the VST device. For example, VST latency may create a delay between the user pointing to or selecting a real-world object on the display(s) of the VST device and the VST device responding to that user input. As an example, a delay between the user touching an object and a cursor or pointer on the display of the VST device reacting to the user touch makes it difficult for the user to select or manipulate objects with any precision thereby making interaction with the VST device unwieldy and/or making the VST device unusable.

VST latency may also limit the contexts and/or use cases of the VST device. Too much latency may render the VST device unusable for certain real-time applications. Providing augmented overlays for a sporting activity or providing augmented overlays that guide a surgeon during a surgical procedure, for example, require very low latency for the VST device to be useful in these situations.

### SUMMARY

In one or more embodiments, a system includes a Visual See-Through (VST) pipeline circuit capable of processing image data. The VST pipeline circuit is embodied as a die. The VST pipeline circuit includes an Image Signal Processing (ISP) circuit and a Display Processing Unit (DPU) circuit coupled to the ISP circuit. The VST pipeline circuit includes a memory circuit coupled to the ISP circuit and to the DPU circuit. The memory circuit is configured to implement a plurality of buffers that provide temporary storage to provide low latency transfer of the pixels of the image data between the ISP circuit and the DPU circuit.

In one or more embodiments, a method includes processing image data through a first portion of a VST pipeline circuit including an ISP circuit having a first plurality of hardened circuit blocks. The first plurality of hardened circuit blocks of the ISP circuit are coupled by a first plurality of buffers of an on-die memory. The method includes processing image data output from the ISP circuit through a second portion of the VST pipeline circuit including a Display Processing Unit (DPU) circuit having a second plurality of hardened circuit blocks. The second plurality of hardened circuit blocks of the DPU circuit are coupled by a second plurality of buffers of the on-die memory.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments; however, the accompanying drawings should not be taken to limit the disclosed technology to only the embodiments shown. Various aspects and advantages will become apparent upon review of the following detailed description and upon reference to the drawings.

FIG. 1 illustrates an electronic device in accordance with one or more embodiments of the disclosed technology.

FIG. 2 illustrates the electronic device of FIG. 1 in accordance with one or more other embodiments of the disclosed technology.

FIG. 3 illustrates the electronic device of FIG. 1 in accordance with one or more other embodiments of the disclosed technology.

FIG. 4 illustrates an Image Signal Processor (ISP) in accordance with one or more embodiments of the disclosed technology.

FIG. 5 illustrates Bayer stage circuitry of the ISP of FIG. 4 in accordance with one or more embodiments of the disclosed technology.

FIG. 6 illustrates YUV stage circuitry of the ISP of FIG. 4 in accordance with one or more embodiments of the disclosed technology.

FIG. 7 illustrates a time warping circuit in accordance with one or more embodiments of the disclosed technology.

FIG. 8 illustrates a Display Processing Unit (DPU) in accordance with one or more embodiments of the disclosed technology.

FIG. 9 illustrates multi-channel blending circuitry of the DPU of FIG. 8 in accordance with one or more embodiments of the disclosed technology.

FIG. 10 illustrates post-blending circuitry of the DPU of FIG. 8 in accordance with one or more embodiments of the disclosed technology.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuits and, more particularly, to video processing circuit architectures for use in ICs including System-on-Chip(s) (SoCs). In accordance with the inventive arrangements, methods, systems, and computer program products are provided that implement a low latency, Video See-Through (VST) pipeline circuit. In one or more embodiments, the VST pipeline circuit is capable of providing or rending high-quality video while also reducing VST latency. As such, the VST pipeline circuit increases user comfort and preserves augmented reality (AR) and/or mixed reality (MR) immersion and realism.

In one or more embodiments, the VST pipeline circuit may be implemented in an integrated circuit (IC) and, more particularly, as a single die. For example, the VST pipeline circuit may be implemented on a single piece or portion of silicon. As an example, the VST pipeline implemented on a single piece of silicon may be included or part of a System-on-Chip (SoC). In one or more embodiments, the VST pipeline circuit, as realized on a single die, may be part of a larger system. For example, the VST pipeline circuit also may be implemented on a die such as a chiplet that may be included in an IC package with one or more other dies or chiplets. Further, the VST pipeline circuit may be included within one or more larger electronic systems and/or devices.

In one or more embodiments, the VST pipeline circuit may include an Image Signal Processor (ISP) circuit and a Display Processing Unit (DPU) circuit. Further, the VST pipeline circuit may include on-die buffers. The on-die buffers may be implemented in an on-die memory such as a Static Random-Access Memory (SRAM) or an embedded Dynamic Random-Access Memory (e-DRAM) that is disposed or implemented on the same die as the ISP circuit and the DPU circuit. The on-die buffers may be used for both the ISP circuit and for the DPU circuit. The use of on-die buffers facilitates the low latency operation of the ISP circuit and the DPU circuit. The on-die buffers facilitate operation of the ISP circuit and the DPU circuit with reduced latency compared to locating the plurality of buffers off-die (e.g., in DRAM). The use of the on-die buffers also may eliminate or reduce the need to access off-die memory such as Dynamic RAM (DRAM) when processing image data through the VST pipeline circuit.

Implementation of the VST pipeline circuit in a single die provides additional benefits. With both the ISP circuit and the DPU circuit being located in a same die, signal paths between the two circuit blocks may be optimized. High-speed circuit interconnections between the constituent circuit blocks of the ISP circuit, the constituent circuit blocks of the DPU circuit, and between the ISP circuit and DPU circuit may be used. The VST pipeline circuit, for example, may implement direct, in-die connections between the ISP circuit and the on-die buffers, between the DPU circuit and the on-die buffers, and between the ISP circuit and the DPU circuit. The use of the on-die buffers allows all of the image data to be kept on die for the duration of the image or pixel processing and transport. The high-speed interconnects and ability to keep all image data on the die both serve to reduce latency and power consumption of the VST pipeline circuit.

In one or more embodiments, one or more image processing functions that are typically performed using software are implemented in hardened circuit blocks. For example, one or more functions implemented as software executing on a Graphics Processing Unit (GPU) may be hardened. The hardened circuit block may be incorporated into the VST pipeline circuit and, more particularly, into the DPU circuit. By hardening software-based image processing functions that typically execute on a GPU and incorporating such functions in the VST pipeline circuit, further reductions in latency and/or power reduction may be achieved.

In one or more other examples, a motion warping function typically performed using software in the ISP circuit may be hardened. In a conventional VST pipeline circuit, motion warping is implemented as a software function executed in the ISP by a processor therein. In accordance with the inventive arrangements, the motion warping function is implemented as a hardened circuit block. The motion warping circuit block may operate concurrently with the ISP as a separate or independent background process. The operation of the hardened motion warping circuit in parallel and separate from the ISP circuit further reduces latency of the overall VST pipeline circuit.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

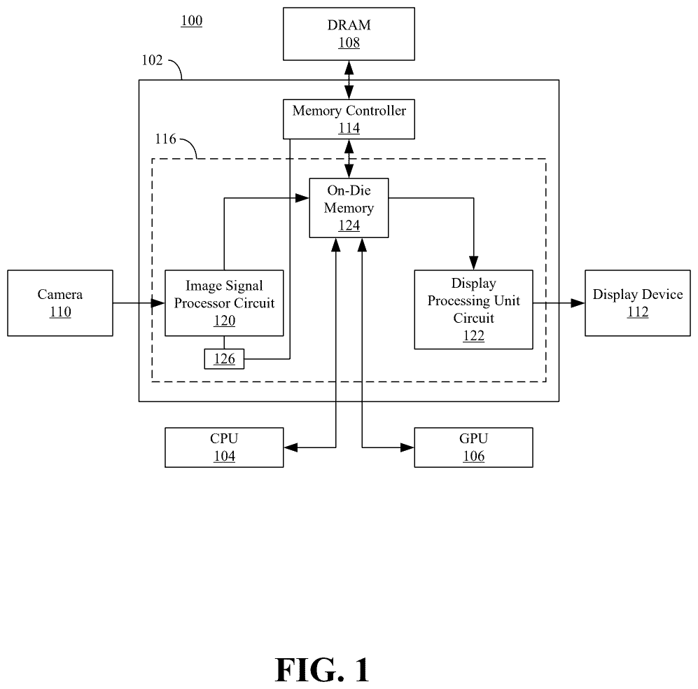

FIG. 1 illustrates an electronic device 100 in accordance with one or more embodiments of the disclosed technology. Electronic device 100 is capable of performing image processing. In the example, electronic device 100 includes a die 102, a Central Processing Unit (CPU) 104, a GPU 106, a DRAM 108, a camera 110, and a display device 112. In the example, die 102 includes a memory controller 114 and a VST pipeline circuit 116. VST pipeline circuit 116 includes an ISP circuit 120, a DPU circuit 122, and a memory circuit such as on-die memory 124. VST pipeline circuit 116 also may include a time warping circuit 126.

The image data feed that originates with camera 110 and continues through ISP circuit 120, on-die memory 124, DPU circuit 122, and ends with display device 112 is often considered the critical path that must be implemented with low latency (e.g., “the low latency data path”) for a VST device. In general, ISP circuit 120 is capable of performing image processing operations relating to image data output from camera 110. DPU circuit 122 is capable of blending digital content items generated by GPU 106 with the image data generated by camera 110. VST pipeline circuit 116 encapsulates or includes the low latency data path through which image data is conveyed from camera 110 to display device 112 and, as such, has the largest influence over VST latency of any system in which VST pipeline circuit 116 is included. In one or more embodiments, VST pipeline circuit 116 is capable of achieving a VST latency of approximately 10 milliseconds or less.

Camera 110 may be implemented using any of a variety of digital image capture technologies. For example, camera 110 may utilize one or more optical sensors such as a charged coupled device (CCD), a complementary metal-oxide semiconductor (CMOS) optical sensor, or the like. In one or more embodiments, camera 110 is implemented as a digital Red-Green-Blue (RGB) camera. Camera 110 is capable of capturing and outputting image data as frames, e.g., video as a sequence of such frames, of real-world scenes or views and outputting the image data to ISP circuit 120.

Within this disclosure, a frame refers to digital data specifying an image. Appreciably, video may be specified as a sequence of a plurality of frames (e.g., images). In addition, within this disclosure, the term “image data” may refer to an entire frame or to a portion of a frame, e.g., one or more lines of the frame. Image data, as processed through VST pipeline circuit 116, may be specified or formatted and/or transformed into one or more different image encoding formats and/or one or more different color spaces. Those skilled in the art will appreciate that the particular image encodings, formatting, compression/decompression techniques, and/or color spaces discussed are for purposes of illustration and not limitation.

ISP circuit 120 is capable of performing various image processing operations described in greater detail hereinbelow. As noted, ISP circuit 120 is capable of processing image data generated and output by camera 110. In the example, ISP circuit 120 is coupled to on-die memory 124. In one or more embodiments, ISP circuit 120 is also coupled to a time warping circuit 126. Time warping circuit 126 is capable of performing temporal filtering. Time warping circuit 126, being a hardened circuit block, implements particular functions that, in a conventional VST pipeline, were implemented as software executed by the ISP. In the example of FIG. 1, time warping circuit 126 is capable of operating concurrently with ISP circuit 120 as a background process implemented outside, or separately from, ISP circuit 120. In general, time warping circuit 126 utilizes prior frames that may be obtained from DRAM 108 to calculate motion vectors, which reduces or eliminates delay in waiting for the current frame. As described in greater detail hereinbelow, time warping circuit 126 is capable of operating in parallel with ISP circuit 120 and, in this regard, is not part of the low latency data path described despite being included in VST pipeline circuit 116.

DPU circuit 122, as noted, is capable of blending image data output from ISP circuit 120 with digital content items generated and/or output from GPU 106 into merged image data (e.g., one or more merged frames specifying video). For example, DPU circuit 122 is capable of overlaying one or more digital content items as generated by GPU 106 on the image data. DPU circuit 122 is coupled to display device 112 and also to on-die memory 124. As noted, DPU circuit 122 may include one or more hardened circuit blocks configured to perform image processing functions that were conventionally performed as software executable operations in GPU 106. DPU circuit 122 optionally may include one or more additional hardened circuit blocks to be described in greater detail hereinbelow.

On-die memory 124 is configured to provide or implement a plurality of on-die buffers that may be used by ISP circuit 120 and DPU circuit 122. In the example, CPU 104 and GPU 106 also may access on-die memory 124. The circuit architecture illustrated in FIG. 1 allows ISP circuit 120 and DPU circuit 122 to access data on-die without having to utilize memory controller 114 to access off-die DRAM 108. In this regard, the data path of VST pipeline circuit 116, which effectively moves frames from camera 110 to display device 112, is kept entirely on-die, e.g., within die 102.

In one or more embodiments, on-die memory 124 may be implemented as a plurality of SRAMs. In one or more other embodiments, on-die memory 124 may be implemented as a plurality of e-DRAMs. The on-die memory 124 may be implemented as a plurality of SRAMs or a plurality e-DRAMs, as the case may be, of different types having different response times and/or capacities arranged into a memory hierarchy. For example, the on-die buffers may be implemented using a memory hierarchy that includes a Level 1 (L1) cache with a smallest capacity and fastest response time and a Level 2 (L2) cache having a larger capacity than the L1 cache and a slower response time that the L1 cache. The L2 cache may operate as an intermediary between the L1 cache and DRAM 108. In one or more embodiments, on-die memory 124 may be implemented by partitioning a system cache and enabling the system-cache-as-SRAM/e-DRAM feature for a partition used to implement VST pipeline(s).

Display device 112 may be implemented as any of a variety of display screens. For example, display device 112 may be implemented as a liquid crystal display (LCD), a light emitting diode (LED) display, an organic light emitting diode (OLED) display, a quantumdot light emitting diode (QLED) display, a microelectromechanical systems (MEMS) display, or an electronic paper display. Display device 112 may be implemented as a depth-aware display, such as a multi-focal display. Display device 112 is capable of displaying, for example, various types of content such as text, images, videos, icons, symbols, and the like, to a user. In one or more embodiments, display device 112 may include a touchscreen and may receive, for example, a touch, gesture, proximity, or hovering input using an electronic pen or a body portion of the user.

Central Processing Unit (CPU) 104 is capable of controlling operation of VST pipeline circuit 116. For example, CPU 104 is capable of implementing or managing the control path of the low latency data path implemented by VST pipeline circuit 116 by controlling operation of the various circuit blocks of VST pipeline circuit 116 and/or GPU 106.

CPU 104 may be implemented as one or more hardware processors. CPU 104 may be implemented as one or more circuits capable of executing computer-readable program instructions (program instructions). In one or more examples, CPU 104 may include one or more cores, for example, where each core is capable of executing computer-readable program instructions. CPU 104 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

GPU 106 is capable of generating the digital content items that may be overlayed, or super-imposed, over image data originating in camera 110. GPU 106 may be implemented as one or more hardware processors. GPU 106, for example, may include a plurality of cores or compute units that are particularly suited for performing graphics and/or image processing operations.

In the example of FIG. 1, CPU 104 and GPU 106 are not disposed on the die 102 with VST pipeline circuit 116. For example, die 102 may be implemented as a chiplet while CPU 104 and GPU 106 are implemented in one or more other chiplets coupled to die 102. In one or more embodiments, die 102, CPU 104, and GPU 106 may be disposed in the same IC package or in different IC packages.

Electronic device 100 may be implemented as, or within, any of a variety of different types of systems in which video from a camera, or cameras, is to be delivered in substantially real-time to a display or displays. Electronic device 100 may be embodied as a computer system, a communication device, an information appliance, or the like. In one or more embodiments, electronic device 100 may be integrated into a wearable device or an electronic device-mountable wearable device such as a head-mounted device (HMD). For example, electronic device 100 may represent an AR wearable device, such as a headset or smart eyeglasses. In the case of certain HMDs, elements of VST pipeline circuit 116 may be duplicated to work with an additional camera and an additional display device. For example, a second ISP circuit 120 (e.g., and a second time warping circuit 126) and a second DPU circuit 122 may be included. The additional components may utilize the same on-die memory 124 for on-die buffers, but constitute a further VST pipeline circuit.

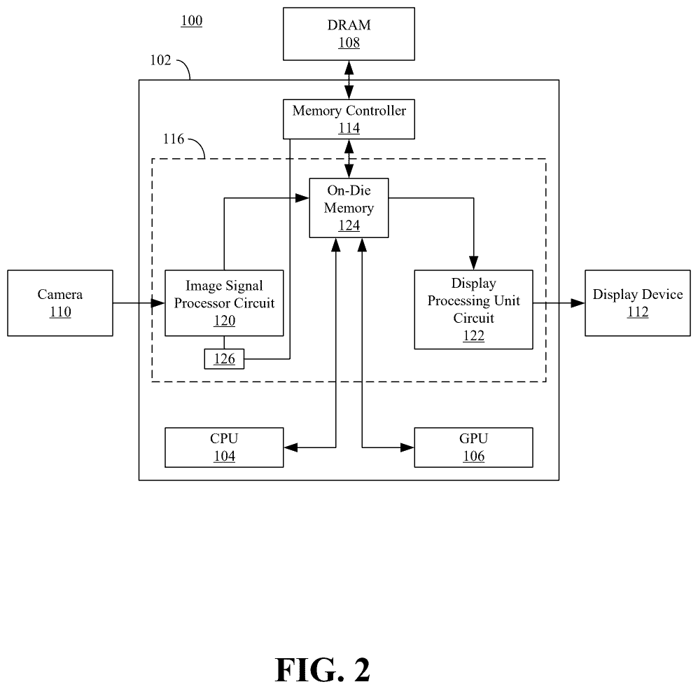

FIG. 2 illustrates electronic device 100 in accordance with one or more other embodiments of the disclosed technology. In the example of FIG. 2, electronic device 100 is implemented substantially the same as described in connection with FIG. 1 with the exception that CPU 104 and GPU 106 are included in die 102. That is, both CPU 104 and GPU 106 are included in the same die as VST pipeline circuit 116.

In one or more embodiments, GPU 106 may be disposed on die 102 with VST pipeline circuit 116 while CPU 104 is implemented off-die. In still one or more other embodiments, CPU 104 may be disposed on die 102 with VST pipeline circuit 116 while GPU 106 is implemented off-die.

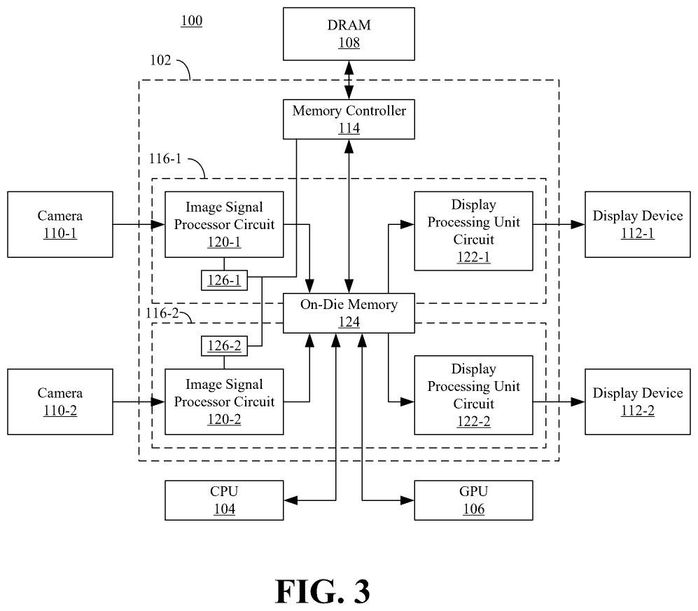

FIG. 3 illustrates electronic device 100 in accordance with one or more other embodiments of the disclosed technology. In the example of FIG. 3, electronic device 100 is implemented substantially the same as described in connection with FIG. 1 albeit with what is effectively two VST pipeline circuits that share on-die memory 124. As illustrated, die 102 includes VST pipeline circuit 116-1 and VST pipeline circuit 116-2. VST pipeline circuit 116-1 receives image data from camera 110-1 and processes the image data through ISP circuit 120-1 and DPU circuit 122-1. DPU circuit 122-1 is coupled to display device 112-1. ISP circuit 120-1 is also coupled to time warping circuit 126-1. VST pipeline circuit 116-2 receives image data from camera 110-2 and processes the image data through ISP circuit 120-2 and DPU circuit 122-2. DPU circuit 122-2 is coupled to display device 112-2. ISP circuit 120-2 is also coupled to time warping circuit 126-2. In the example of FIG. 3, each of time warping circuit 126-1 and time warping circuit 126-2 may operate in parallel with respect to ISP circuit 120-1 and ISP circuit 120-2, respectively. In this regard, time warping circuit 126-1 is not part of the low latency data path implemented by VST pipeline circuit 116-1 and time warping circuit 126-2 is not part of the low latency data path implemented by VST pipeline circuit 116-2.

In electronic device 100, camera(s) 110 may operate as a proxy or stand-in for the eye(s) of a human being. In the example of FIG. 3, there is one ISP circuit and one DPU circuit set for each eye. A single on-die memory, a single CPU, and a single GPU may be used. In this regard, GPU 106 is capable of generating digital content items that may be provided to both DPUs. In embodiments where electronic device 100 is incorporated into an HMD, VST pipeline circuits 116-1 and 116-2 implement two channels corresponding to the user's eyes, where the visual field of each camera 110-1 and 110-2 is offset by a distance corresponding to the inter-pupilar distance of the user so as to generate slightly different points of view for the user to perceive and assess depth.

In the example of FIG. 3, both CPU 104 and GPU 106 are disposed or located off-die. In one or more embodiments, both CPU 104 and GPU 106 may be disposed on die 102. In one or more other embodiments, GPU 106 may be disposed on die 102 with VST pipeline circuit 116 while CPU 104 is implemented off-die. In still one or more other embodiments, CPU 104 may be disposed on die 102 with VST pipeline circuit 116 while GPU 106 is implemented off-die.

In each of the embodiments illustrated in FIGS. 1, 2, and 3, CPU 104 is capable of controlling operation of VST pipeline circuit 116, VST pipeline circuit 116-1, and/or VST pipeline circuit 116-2 as the case may be. Further, GPU 106 is capable of generating and providing digital content items to DPU circuit 122, DPU circuit 122-1, and/or DPU circuit 122-2 as the case may be. That is, while an additional VST pipeline circuit may be included in die 102, there is no need to incorporate an additional CPU and/or GPU.

In one or more embodiments, time warping circuit 126, whether in the example of FIG. 1, FIG. 2, or FIG. 3, may be incorporated into ISP circuit 120. That is, in one or more embodiments, time warping circuit 126 may be implemented as a hardened circuit block that operates in parallel with other blocks that are part of the low latency data path of ISP circuit 120. In this regard, time warping circuit 126 (or time warping circuit 126-1 and/or time warping circuit 126-2) may be included in ISP circuit 120 (or ISP circuit 120-1 and/or ISP circuit 122-2), but remain outside of the low latency data path.

In the embodiments below, particular on-die memory buffers (also referred to and/or illustrated as “ODM buffers” formed or implemented using on-die memory 124) configurations are illustrated. To achieve a VST latency of 10 milliseconds or less, image data must be efficiently moved from ISP circuit 120 to DPU circuit 122. Efficient movement of image data may occur using the ODM buffers. In doing so, the ODM buffers may have a capacity (e.g., storage capability) of approximately the size of 20 lines for each camera 110. In embodiments with two cameras, the capacity that is needed is approximately 0.6 MB. It should be appreciated that the amount of on-die memory and actual size of each ODM buffer 124 will vary with the resolution of the cameras and/or the display devices and the bit resolution of the image data. The pixel data that is propagated through VST pipeline circuit 116 may be partitioned into finite size portions to be processed thereby leveraging the benefits of the hardware pipeline architecture described herein and providing deterministic image processing as performed by VST pipeline circuit 116 to keep latency low.

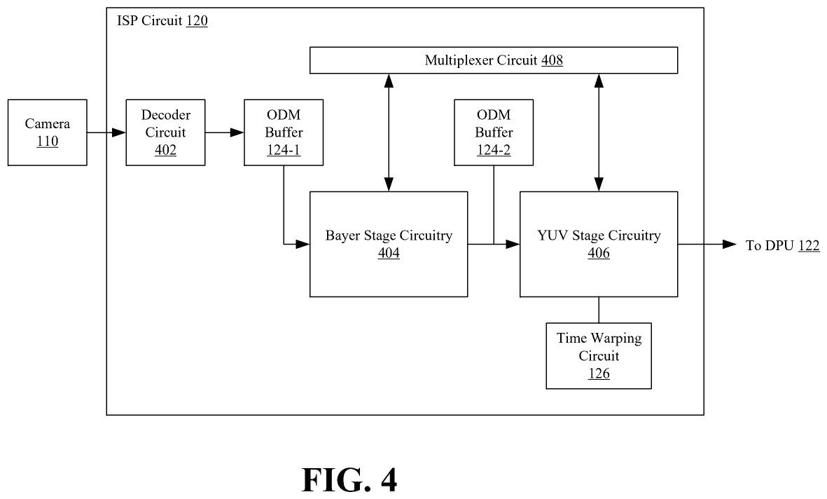

FIG. 4 illustrates ISP circuit 120 of VST pipeline circuit 116 in accordance with one or more embodiments of the disclosed technology. The example of FIG. 4 may be used to implement ISP circuit 120 in any one of FIG. 1, 2, or 3. In the example of FIG. 4, ISP circuit 120 is capable of receiving image data from camera 110. As illustrated, decoder circuit 402 receives image data, decodes the image data, and stores the decoded image data within ODM buffer 124-1. Within this disclosure, the various on-die buffers utilized are referenced with the same reference number used for on-die memory 124 with the additional term “buffer” as each corresponds to a portion of on-die memory 124 allocated for use as a buffer linking the different hardened circuit blocks shown. ISP circuit 120 includes Bayer stage circuitry 404 and YUV stage circuitry 406. Bayer stage circuitry 404 is coupled to YUV stage circuitry 406 and further may communicate or pass image data via ODM buffer 124-2. YUV stage circuitry 404 is coupled to time warping circuit 126.

In the example, both Bayer stage circuitry 404 and YUV stage circuitry 406 are coupled to multiplexer circuit 408. Inclusion of multiplexer circuit 408 allows different hardened circuit blocks of VST pipeline circuit 116 to be bypassed. For example, as different functions of the VST pipeline circuit 116 are implemented as hardened circuit blocks, the ability to bypass any particular one or more of the hardened circuit blocks allows for any improved image processing techniques and/or algorithms to be incorporated into VST pipeline circuit 116 as such techniques are developed. For example, an improved image processing algorithm may be implemented in CPU 104 or in GPU 106 and performed in place of a hardened circuit block version of the algorithm that is bypassed using multiplexer circuit 408. Though not shown, multiplexer circuit 408, for example, may include data paths or connections with CPU 104 and/or GPU 106 to route data back and forth between CPU 104, GPU 106 and VST pipeline circuit 116. Further, CPU 104 may be tasked with generating the select signals that control multiplexer circuit 408 to bypass one or more selected hardwired circuit blocks of VST pipeline circuit 116.

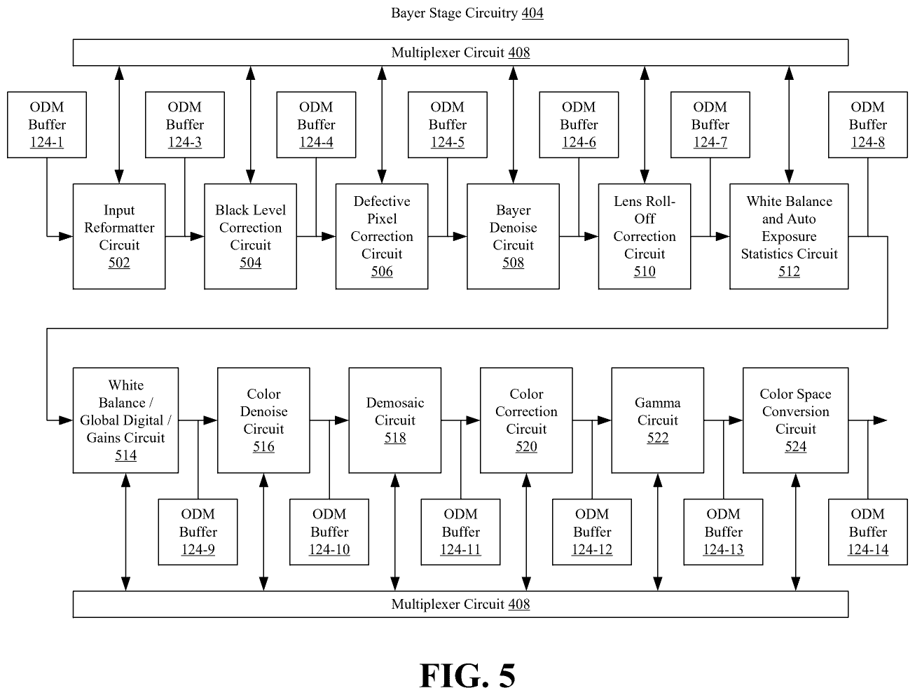

FIG. 5 illustrates Bayer stage circuitry 404 of ISP circuit 120 in accordance with one or more embodiments of the disclosed technology. In the example, Bayer stage circuitry 404 includes the following hardened circuit blocks arranged in a serial data processing pipeline: input reformatter circuit 502, black level correction circuit 504, defective pixel correction circuit 506, Bayer denoise circuit 508, lens roll-off correction circuit 510, white balance and auto exposure statistics circuit 512, color white balance/global digital/gains circuit 514, denoise circuit 516, demosaic circuit 518, color correction circuit 520, gamma circuit 522, and color space conversion circuit 524. As illustrated, these different hardened circuit blocks may be coupled in serial as a pipeline and share data by way of the various ODM buffers 124 (e.g., 124-3, 124-4, 124-5, 124-6, 124-7, 124-8, 124-9, 124-10, 124-11, 124-12, 124-13, and 124-14). Further, each of hardened circuit blocks 502-524 is coupled to multiplexer circuit 408 so that one or more or all of hardened circuit blocks 502-524 may be bypassed based on select (e.g., control) signals provided to multiplexer circuit 408 from CPU 104.

As generally known, Bayer stage processing as performed by Bayer stage circuitry 404 is capable of converting a Bayer pattern into a full-color image from single-color measurements. From the Bayer pattern, a full-color image may be generated from a single image sensor and lens. Input reformatter circuit 502 is capable of unpacking, or decoding, MIPI encoded image data to pixels as RAW image data. MIPI encoded data refers to image data that uses a physical layer interface (PHY) to transfer high-speed serial data between cameras and display devices. Input reformatter circuit 502 is capable of preparing pixel data from the encoded image data received from camera 110 for further processing through VST pipeline circuit 116.

Black level correction circuit 504 is capable of applying a sensor-black offset correction to the pixel data as decoded. Black level correction circuit 504 applies a correction to the noise inherent to all sensors to achieve improved image contrast. Defective pixel correction circuit 506 is capable of correcting defective or dead pixels in the image data to improve image quality. Bayer denoise circuit 508 is capable of denoising the RAW image to reduce noise and artifacts in the image data. Roll-off correction circuit 508 is capable of performing light intensity fall-off correction on the image data to reduce lens artifacts and improve realism of the image data.

White balance and auto exposure statistics circuit 512 is capable of generating statistics for the image data with respect to white balance and auto exposure. The statistics, as generated, may be provided to white balance, global digital, and gains circuit 514. White balance, global digital, and gains circuit 514 is capable of applying the statistics to perform white balancing and digital gain adjustments to the image data that improve uniformity of the image data.

Color denoise circuit 516 is capable of denoising the RAW images in the Bayer domain to reduce color noise, which improves image quality. Demosaic circuit 518 is capable of converting the image data in the RAW format to the RGB color space. Color correction circuit 520 is capable of implementing a color correction matrix and that color converts the color space of the image data from RGB to sRGB, which provides a simpler color space than RGB and is better suited for visual presentation on display device 112. Gamma circuit 522 is capable of performing gamma mapping (e.g., inverse gamma) on the image data to provide further visual enhancement of the image data. Color space conversion circuit 524 is capable of converting the color space from sRGB to YUV420. Converting the color space to YUV420 reduces the bandwidth required for further processing of the image data and reduces the amount of storage (e.g., on-die memory 124) needed to store the image data along VST pipeline circuit 116.

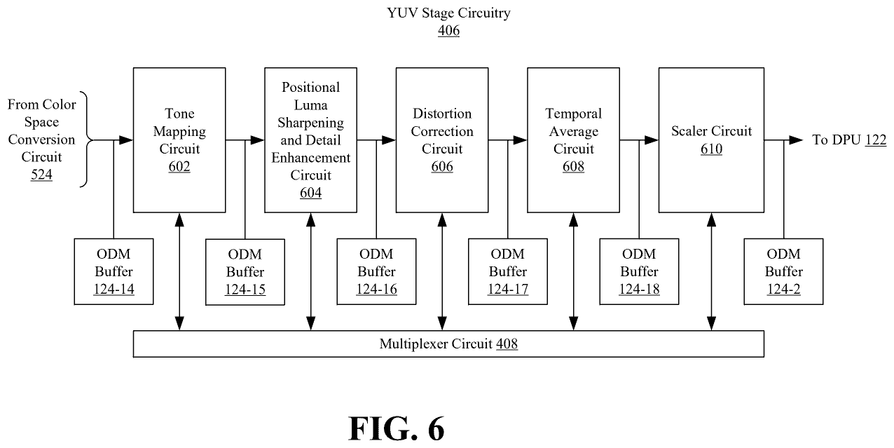

FIG. 6 illustrates YUV stage circuitry 406 of ISP circuit 120 in accordance with one or more embodiments of the disclosed technology. In the example, YUV stage circuitry 406 includes the following circuit blocks arranged in a serial data processing pipeline: tone mapping circuit 602, positional luma sharpening and detail enhancement circuit 604, distortion correction circuit 606, temporal average circuit 608, and scaler circuit 610. As illustrated, these different hardened circuit blocks may be coupled in serial as a pipeline and share data by way of the various ODM buffers 124 (e.g., 124-14, 124-15, 124-16, 124-17, 124-18, and 124-2). Further, each of hardened circuit blocks 602-610 is coupled to multiplexer circuit 408 so that one or more or all of hardened circuit blocks 602-610 may be bypassed based on control signals provided to multiplexer circuit 408 from CPU 104.

Tone mapping circuit 602 is capable of adjusting color tones of the image data so that the images as displayed on display device 112, which may have a limited dynamic range, appear to have a higher dynamic range. Positional luma sharpening and detail enhancement circuit 604 is capable of correcting for lens properties by applying additional sharpening to periphery regions of the image data rather than the center region. This compensates for lens artifacts and improves realism in the image data. Distortion correction circuit 606 is capable of correcting geometric distortion (e.g., pincushion and barrel type distortion) in the image data to correct further lens artifacts and improve realism. Temporal average circuit 608 is capable of performing motion warping for temporally denoising the image data. This process removes motion picture artifacts. Scaler circuit 610 is capable of scaling the image data to correspond to a selected display resolution (e.g., the resolution of display device 112) thereby matching the image size to display device 112.

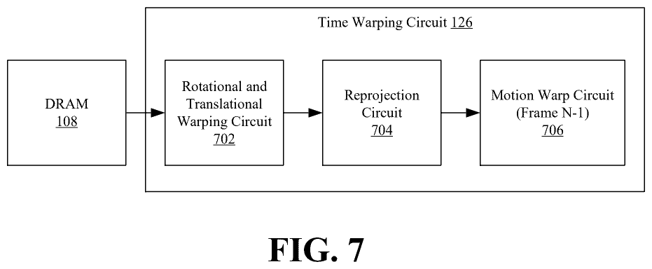

FIG. 7 illustrates time warping circuit 126 in accordance with one or more embodiments of the disclosed technology. Time warping circuit 126 is capable of generating coefficients specifying motion vectors based on prior frames and providing the motion vectors to temporal average circuit 608 of FIG. 6 which performs time warping on a current frame using the motion vectors. By implementing time warping circuit 126 as a separate and parallel processing path with respect to other hardened circuit blocks of ISP circuit 120, latency of VST pipeline circuit 116 may be reduced. In addition, only minimal buffering for the current frame as processed through ISP circuit 120 is required.

As discussed, time warping circuit 126 is not part of the low latency data path (whether in reference to the entire low latency data path or the portion thereof through ISP circuit 120). In this regard, it may be observed that time warping circuit 126 receives data from DRAM 108 by way of memory controller 114 (not shown) as opposed to on-die memory 124. Such is the case as time warping circuit 126 operates on multiple frames (e.g., entire frames) to generate the parameters provided to temporal average circuit 608. The frames are stored in DRAM 108 since the respective ODM buffers are sized, in general, to store no more data that is needed for the various hardened circuit blocks shown, which is often several lines of a frame in each respective buffer.

In the example of FIG. 7, time warping circuit 126 includes a rotational and translational warping circuit 702, a reprojection circuit 704, and a motion warp circuit 706. In one or more embodiments, each of rotational and translational warping circuit 702, reprojection circuit 704, and motion warp circuit 706 is implemented as a hardened circuit block and arranged in a serial pipeline configuration rather than being implemented as an executable software process executed by the ISP circuit. As noted, ISP circuit 120 generates frames line by line. In one or more embodiments, the image data output from ISP circuit 120, e.g., from scaler circuit 610, may be provided to an ODM buffer that feeds DPU circuit 122. The image data output from scaler circuit 610 may also be accumulated in DRAM 108 so that DRAM 108 may accumulate several frames. For example, the three most recent frames generated by ISP circuit 120 may be stored in DRAM 108 for use by time warping circuit 126. Appreciably, time warping circuit 126 may run in parallel with ISP circuit 120 because time warping circuit 126 operates on past frames, e.g., past whole frames, to calculate the parameters used by temporal average circuit 608 in processing the current frame. Because time warping circuit 126 operates in parallel with ISP circuit 120 and, as such, outside of the low latency data pipeline, time warping circuit 126 may pull data from DRAM 108 without incurring any reduction in performance of the larger system.

As an illustrative and non-limiting example, consider frames N, N-1, and N-2, where frame N is the current frame being processed through ISP circuit 120, frame N-1 is the frame immediately prior to frame N, and frame N-2 is the frame immediately prior to frame N-1. In this example, as lines of frames are output from ISP circuit 120, DRAM 108 accumulates the lines such that frames N-1 and N-2 are stored therein. Time warping circuit 126 uses frames N-2 and N-1 to compute coefficients that are provided to temporal average circuit 608 and applied to lines of frame N as frame N is being processed by ISP circuit 120. As frame N is processed and accumulated in DRAM 108, frame N becomes frame N-1, frame N-1 becomes frame N-2, and the prior frame N-2 is deleted or overwritten.

In general, time warping circuit 126 performs the following functions. Rotation and translational warping circuit 702 is capable of calculating motion vectors for each pixel based on the previous frames (e.g., frames N-2 and N-1) and a latest head pose calculation. Reprojection circuit 704 is capable of calculating coefficients for the temporal filter on each pixel. Motion warp circuit 706 is capable of motion warping frame N-1 using a latest head pose to denoise motion related noise and improve registration. Motion warp 706 is capable of providing the data as generated to temporal average circuit 608, which applies the motion compensated temporal filter to pixels in frame N to denoise the frame. Temporal average circuit 608 uses the values of the same pixel at different points in time to filter out temporal noise in the image data. Temporal average circuit 608 takes into account any motion in a target scene obtained by the motion vectors as calculated by time warping circuit 126, which helps to reduce motion artifacts.

Regarding the order of the blocks in the time warping circuit 126, the logical flow determines the order of these blocks. For example, the warping operation needs to produce some data that the following blocks can consume and perform their function (specifically, for example, the temporal average circuit 608 consumes this information produced offline by the warping operation and performs Temporal averaging/filtering based on this information).

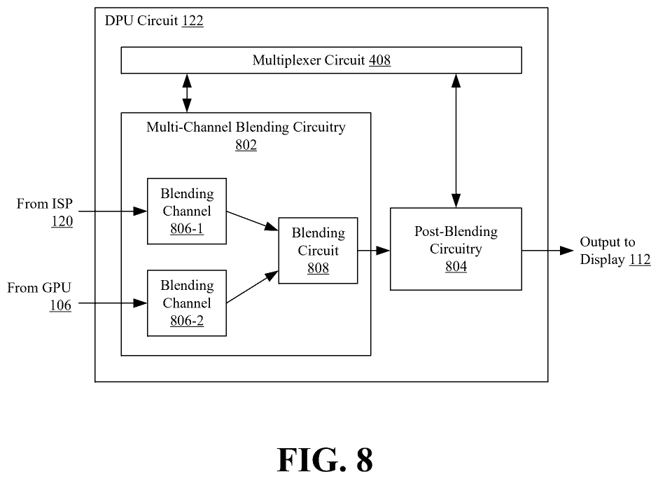

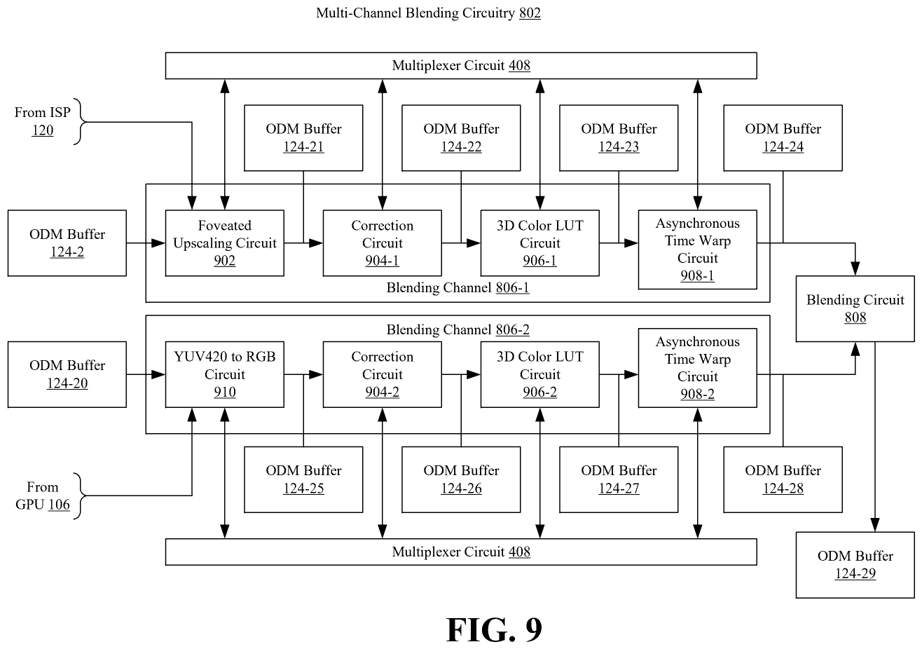

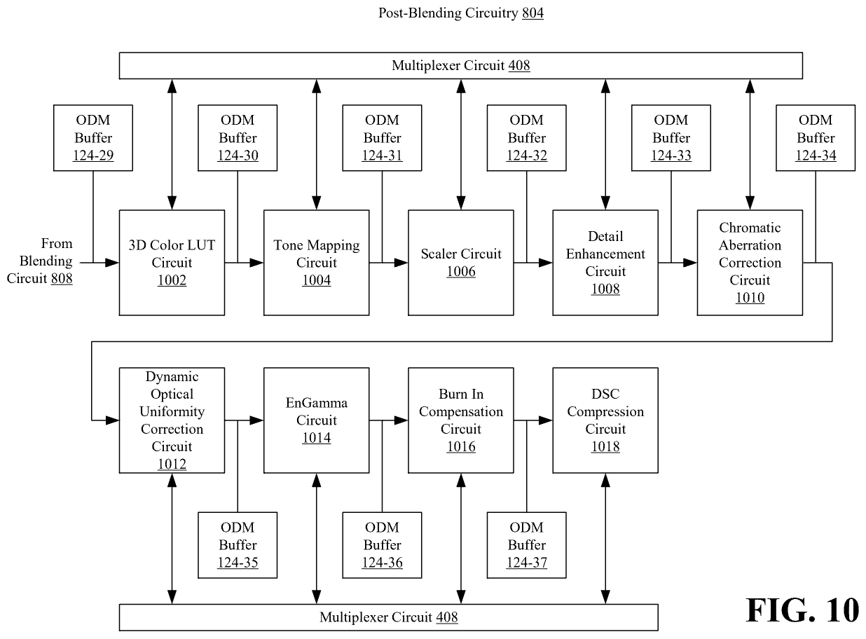

FIG. 8 illustrates DPU circuit 122 of VST pipeline circuit 116 in accordance with one or more embodiments of the disclosed technology. In the example of FIG. 8, ODM buffers are not illustrated. ODM buffers of DPU circuit 122 are illustrated in greater detail in connection with FIGS. 9 and 10. The example of FIG. 8 may be used to implement DPU circuit 122 in any one of FIG. 1, 2, or 3. In the example of FIG. 8, DPU circuit 122 includes multi-channel blending circuitry 802 and post-blending circuitry 804. Multi-channel blending circuitry 802 includes two separate blending channels 806-1 and 806-2. As illustrated, blending channel 806-1 receives image data from ISP circuit 120. Blending channel 806-2 receives digital content items such as text, graphics, a user interface, or other digital content generated by GPU 106. Post-blending circuitry 804 is capable of outputting the resulting image data as blended image data to display device 112. The blended image data may be embodied as one or more blended frames. The blended frames may be referred to herein as a unified composited frame or a composited frame. Though not illustrated in FIG. 8, the resulting image data output from post-blending circuitry 804 may be compressed for conveyance to display device 112. Display device 112 may decompress the data and present the image data thereon.

FIG. 9 illustrates multi-channel blending circuitry 802 of DPU circuit 122 in accordance with one or more embodiments of the disclosed technology. In the example of FIG. 9, ODM buffer 124-2 receives data output from scaler circuit 610 of ISP circuit 120. ODM buffer 124-20 receives data, e.g., digital content items, generated by and output from GPU 106. In the example of FIG. 9, blending channel 806-1 and blending channel 806-2 are implemented with one or more similar or same hardened circuit blocks. As shown, blending channel 806-1 includes a foveated upscaling circuit 902, a correction circuit 904-1, a 3D color LUT circuit 906-1, and an asynchronous time warp circuit 908-1. Blending channel 806-2 includes a YUV to RGB circuit 910, a correction circuit 904-2, a 3D color LUT circuit 906-2, and an asynchronous time warp circuit 908-2.

In one or more embodiments, the particular hardened circuit blocks illustrated in each of blending channel 806-1 and blending channel 806-2 implement, in dedicated hardware, functions typically performed by GPU 106. As illustrated, these different hardened circuit blocks, i.e., hardened circuit blocks 902, 904-1, 906-1, and 908-1, and hardened circuit blocks 910, 904-2, 906-2, and 908-2, may be coupled in serial as a pipeline and share data by way of the various ODM buffers 124. For example, blending channel 806-1 uses ODM buffers 124-21, 124-22, 124-23, and 124-24. Blending channel 806-2 uses ODM buffers 124-25, 124-26, 124-27, and 124-28. Further, each of hardened circuit blocks 902, 904-1, 906-1, 908-1, 910, 904-2, 906-2, and 908-2 is coupled to multiplexer circuit 408 so that one or more or all of the hardened circuit blocks may be bypassed based on control signals provided to multiplexer circuit 408 from CPU 104.

In the example of FIG. 9, one or more of the hardened circuit blocks in blending channel 806-1 and in blending channel 806-2 are optional and may be omitted in certain embodiments. In one or more embodiments, for example, 3D color LUT circuit 906-1 may be omitted from blending channel 806-1. Similarly, 3D color LUT circuit 906-2 may be omitted from blending channel 806-2.

With reference to blending channel 806-1, foveated upscaling circuit 902 is capable of performing scaling and upscaling of the foveal region and the peripheral region of image data to match the resolution of the image data with the resolution of display device 112. Foveated upscaling circuit 902 may upscale the foveal region of a frame and the peripheral region of the frame differently. That is, foveated upscaling circuit 902 may apply different, e.g., higher scaling to the foveal region of a frame compared to the peripheral region of the frame. The foveal region of the frame is the region of the frame at which the user is looking based on eye and/or retina tracking information, for example. The peripheral region of the frame refers to the regions or portions of the frame at which the user is not looking. Eye and/or retina tracking information (not shown) may be provided to foveated upscaling circuit 902 for use detecting the foveated region of the frame and performing the upscaling.

In one or more embodiments, correction circuit 904-1 is capable of applying one or more corrections to the image data. For example, correction circuit 904-1 is capable of correcting for distortion warp (e.g., one or more lens distortions) and correcting for shearing warp in frames of the image data.

Correction circuit 904-1 is also capable of removing the pupil swim effect from the image data. The pupil swim effect refers to image distortion that occurs with a change in eye gaze position. The pupil swim effect may result from incorrect compensation of the distortion profile for the image data in XR applications. The distortion profile requires calibration offline for different eye gaze positions. Application of the distortion profile as generated performs interpolation to compensate for the pupil swim effect in real-time based on eye tracking data (not shown) that is provided to the correction circuit 904-1. Since pupil swim correction, lens distortion and shearing correction all involve applying some correction (typically looking up from a look up table), they can be semantically combined into one block.

In one or more embodiments, correction circuit 904-1 is capable of performing rolling shutter correction. Correction circuit 904-1 is capable of compensating for artifacts caused by eye movements for contents displayed on a rolling shutter, low persistence, display. For example, correction circuit 904-1 is capable of compensating for shear and compression artifacts in the image data to produce higher image quality.

In the example of FIG. 9, because rolling shutter correction, pupil swim correction, lens distortion correction, and shearing warp correction all involve applying some type of correction that may be implemented using a lookup table circuit architecture, these different types of corrections implemented by correction circuit 904-1 may be combined into this single hardened circuit block. Still, in one or more embodiments, one or more or each of the different types of corrections may be split out and implemented as a separate hardened circuit block in the pipeline circuit architecture of blending channel 806-1.

3D color look-up table (LUT) circuit 906 (e.g., in reference to each of hardened circuit blocks 906-1 and 906-2) is capable of performing color correction. 3D color LUT circuit 906 may be implemented using a lookup-table circuit architecture that stores color enhancement data. Based on certain color values in certain regions of the image data received, 3D color LUT circuit 906 is capable of looking up corrected color values from the lookup table therein and outputting the corrected color values. 3D color LUT circuit 906 produces higher fidelity in one or more regions of the image data and/or higher fidelity for color space conversion of spatial effects.

Asynchronous time warp circuit 908 is capable of implementing a late-stage warp function on the image data. For example, asynchronous time warp circuit 908 is capable of performing operations such as time warping, also known as reprojection, to warp a rendered image prior to forwarding the image to a display to correct for any head movement of the user that may have occurred after rendering. Asynchronous time warp circuit 908 is capable of performing warping operation(s) asynchronously (and in parallel) with rendering operations of image data. Asynchronous time warp circuit 908, for example, is capable of generating a new time-warped frame from a latest frame of image data to fill in for any missed frames and reduce judder.

Referring to blending channel 806-2, YUV420 to RGB circuit 910 is capable of performing color space conversion of the image data from the YUV color space to the RGB color space. Correction circuit 904-2 may be implemented substantially similar to correction circuit 904-1. In the example of FIG. 9, correction circuit 904-2 is also capable of performing parallax correction to compensate for the difference in perspective between camera 110 and display device 112. The parallax correction provides improved real-world perception. The remaining blocks of blending channel 806-2 may operate substantially as described in connection with the corresponding blocks of blending channel 806-1.

Blending circuit 808 is capable of combining frame data output from asynchronous time warp circuit 908-1 with frame data output from asynchronous time warp circuit 908-2. More particularly, blending circuit 808 combines image data corresponding to frames originating from camera 110 (e.g., camera frames) and image data corresponding to frames that include digital content items that originate from GPU 106 (graphics frames). Thus, blending circuit 808 is capable of blending camera frames and graphics frames to create a blended frame. The inline hardware implementation of blending circuit 808 results in reduced power consumption of VST pipeline circuit 116. Blending circuit 808 is capable of outputting processed, or blended frame data to ODM buffer 124-29.

In the example of FIG. 9, 3D color LUT circuits 906 are positioned immediately following correction circuits 906 and immediately prior to asynchronous time warp circuits 908. This positioning in the serial signal flow provides improved color accuracy and enhancement for the image data being processed in each respective blending channel 806.

As illustrated in the various examples described herein, VST pipeline circuit 116 is capable of implementing independent processing of the camera data (e.g., from ISP 120) and digital content items (e.g., graphical effects data) that are input into DPU circuit 122 from GPU 106. Such data may, for example, have different resolutions and may or may not be foveate (e.g., may or may not have higher resolution at one or more fixation points of an image than at other points of the image). Independent processing of each data stream allows for accounting for any such differences. The multi-channel blending circuitry 802 illustrated in FIGS. 8 and 9 is illustrative of this independent processing. The two independent image data feeds are blended in DPU circuit 122.

Once the two image data feeds are blended by multi-channel blending circuitry 802 and, more particularly by blending circuit 808, the blended image data continues through the remainder of VST pipeline circuit 116 as a unified composited frame (e.g., a blended frame). The architecture of VST pipeline circuit 116 is capable of performing additional processing and image enhancements that may be applied to the unified composited frame with the unified composited frame eventually being presented to display device 112. In one or more embodiments, the circuit architecture described herein for VST pipeline circuit 116 removes GPU 106 from performing pixel processing in or as part of the low latency path. In removing GPU 106 from the low latency path, GPU 106 illustrative need only supply sideband information. An example of sideband information provided by GPU 106 is depth mesh information. Any digital content items provided from GPU 106 that are used to create a unified composited frame are combined with image data generated by the camera(s) that does pass through the low latency path. The digital content items are combined with the image data processed through the low latency path as received in that the image data in the low latency path continues to flow uninterrupted or without pause as the digital content items need not be combine with particular image frames but are combined with the image data as such digital content items are received.

FIG. 10 illustrates post-blending circuitry 804 of DPU circuit 122 in accordance with one or more embodiments of the disclosed technology. In the example of FIG. 10, post-blending circuitry 804 includes a 3D color LUT circuit 1002, a tone mapping circuit 1004, a scaler circuit 1006, a detail enhancement circuit 1008, a chromatic aberration correction circuit 1010, a dynamic optical uniformity correction circuit 1012, an engamma circuit 1014, a burn-in compensation circuit 1016, and a DSC compression circuit 1018.

In one or more embodiments, the particular hardened circuit blocks 1002-1018 illustrated as part of post-blending circuitry 804 may be coupled in serial as a pipeline and share data by way of the various ODM buffers 124. For example, as illustrated, ODM buffers 124-29, 124-30, 124-31, 124-32, 124-33, 124-34, 124-35, 124-36, and 124-37. Further, each of hardened circuit blocks 1002, 1004, 1006, 1008, 1010, 1012, 1014, 1016, and 1018 is coupled to multiplexer circuit 408 so that one or more or all of the hardened circuit blocks may be bypassed based on control signals provided to multiplexer circuit 408 from CPU 104.

Referring to the hardened circuit blocks of post-blending circuitry 804 with particularity, 3D color LUT circuit 1002 may be implemented and operate as described in connection with other 3D color LUT circuits. In one or more embodiments, 3D color LUT circuit 1002 is optional and may be omitted from post-blending circuitry 804.

Tone mapping circuit 1004 may be implemented and operate as previously described to perform tone mapping to achieve improved or enhanced contrast of the image data.

Scaler circuit 1006 may be implemented and operate substantially as described in connection with other scaler circuits previously described herein. For example, scaler circuit 1006 is capable of scaling the image data to correspond to a selected display resolution (e.g., the resolution of display device 112) thereby matching the image size to display device 112. Detail enhancement circuit 1008 is capable of countering the effects of scalar related blurring. Detail enhancement circuit 1008, for example, is capable of enhancing sharpness by detecting high and mid-frequencies of the image data and enhancing detail of these frequencies to improve sharpness and image quality of the frames.

Chromatic aberration correction circuit 1010 is capable of correcting and/or reducing chromatic artifacts in the image data that occur due to dispersion through the camera lens.

Dynamic optical uniformity correction circuit 1012 is capable reducing brightness roll off. For example, dynamic optical uniformity correction circuit 1012 is capable of applying uniformity correction to the image data and doing so based on eye gaze position.

Engamma circuit 1014 is capable of adding an inverse gamma curve to the image data. Engamma circuit 1014 is capable of countering gamma linearization of the monitor panel of display device 112.

Burn-in compensation circuit 1016 is capable of reducing the effects of burn-in for particular types of monitor panels in display device 112. For example, burn-in compensation circuit 1016 may apply any of a variety of known strategies that reduce burn-in on monitor panels such as Organic Light-Emitting Diode (OLED) monitor panels to extend the life of such monitor panels.

Following the post-blending circuitry 804, one or more additional, hardened circuit blocks may be incorporated into the low latency data path or follow the low latency data path but be inline prior to display device 112. For example, a compression circuit, e.g., a Dynamic Stability Control (DSC) compressor circuit, may be included in-line to reduce the bandwidth needed to send image data from post-blending circuitry 804 to a display driver IC coupled to display device 112. The display driver IC, for example, may control display device 112. Use of a compressor circuit also reduces power consumption. Display device 112, upon received of the image data, may decompress the image data and present the image data, e.g., blended frames, thereon.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage mediums. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “output” means storing in physical memory elements, e.g., devices, writing to a display or other peripheral output device, sending or transmitting to another system, exporting, or the like.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a Digital Signal Processor (DSP), a Graphics Processing Unit (GPU), and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The term “user” refers to a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or two or more, e.g., a plurality, of such mediums) having computer readable program instructions thereon for causing a processor to carry out aspects of the present disclosed technology. Within this disclosure, the term “program code” is used interchangeably with the terms “computer readable program instructions” and “program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A system, comprising:
a Visual See-Through (VST) pipeline circuit capable of processing image data, wherein the VST pipeline circuit is embodied as a die and includes:
an Image Signal Processing (ISP) circuit;
a Display Processing Unit (DPU) circuit coupled to the ISP circuit; and
a memory circuit coupled to the ISP circuit and to the DPU circuit, wherein the memory circuit is configured to implement a plurality of buffers that facilitate low latency operation of the ISP circuit and the DPU circuit.

2. The system of claim 1, wherein the ISP circuit is configured to process image data received from one or more cameras; and
wherein the DPU circuit is configured to generate blended frames by blending image data output from the ISP circuit with image data specifying one or more digital content items generated by a Graphics Processing Unit (GPU).

3. The system of claim 2, wherein the DPU circuit is configured to output the blended frames to a display device.

4. The system of claim 1, wherein the memory circuit is implemented as a static random-access memory or an embedded dynamic random-access memory.

5. The system of claim 1, wherein the ISP circuit comprises a plurality of hardened circuit blocks configured to perform image processing operations coupled by one or more of the plurality of buffers.

6. The system of claim 5, wherein the plurality of hardened circuit blocks are coupled by a multiplexer circuit capable of bypassing one or more selected hardened circuit blocks of the plurality of hardened circuit blocks responsive to control signals.

7. The system of claim 5, further comprising:
a time warping circuit implemented as a hardened circuit block, wherein the time warping circuit is configured to operate concurrently and independently of a low latency data path of the ISP circuit.

8. The system of claim 1, wherein the DPU circuit comprises a plurality of hardened circuit blocks coupled by one or more of the plurality of buffers and configured to perform image processing operations.

9. The system of claim 8, wherein the plurality of hardened circuit blocks are coupled by a multiplexer circuit capable of bypassing one or more selected hardened circuit blocks of the plurality of hardened circuit blocks responsive to control signals.

10. The system of claim 8, wherein the plurality of hardened circuit blocks of the DPU circuit implement, at least in part:
a first blending channel capable of processing image data obtained from a camera;
a second blending channel capable of processing image data generated by a Graphics Processing Unit; and
a blending circuit capable of blending image data output from the first blending channel with image data output from the second blending channel.

11. The system of claim 10, wherein each of the first blending channel and the second blending channel includes one or more of:
a foveated upscaling circuit; or
a correction circuit capable of correcting one or more of distortion warp, shearing warp, or late-stage warp in image data.

12. The system of claim 8, wherein the plurality of hardened circuit blocks include one or more of:
a 3D color lookup table circuit, wherein the 3D color lookup table circuit is configured to store color enhancement data;
a detail enhancement circuit configured to offset an effect of scaler related blurring; or
an optical uniformity correction circuit configured to reduce brightness roll off.

13. The system of claim 1, further comprising:
a Central Processing Unit (CPU) configured to control operation of the DPU circuit and the ISP circuit; and
a Graphics Processing Unit (GPU) configured to generate one or more digital content items to be overlayed on image data output from a camera.

14. The system of claim 13, wherein the CPU is embodied in the die with the ISP circuit, the DPU circuit, and the memory circuit.

15. The system of claim 13, wherein the GPU is embodied in the die with the ISP circuit, the DPU circuit, and the memory circuit.

16. The system of claim 13, wherein the CPU and the GPU are embodied in the die with the ISP circuit, the DPU circuit, and the memory circuit.

17. A method, comprising:
processing image data through a first portion of a Visual See-Through (VST) pipeline circuit including an Image Signal Processor (ISP) circuit having a first plurality of hardened circuit blocks;
wherein the first plurality of hardened circuit blocks of the ISP circuit are coupled by a first plurality of buffers of an on-die memory; and
processing image data output from the ISP circuit through a second portion of the VST pipeline circuit including a Display Processing Unit (DPU) circuit having a second plurality of hardened circuit blocks;
wherein the second plurality of hardened circuit blocks of the DPU circuit are coupled by a second plurality of buffers of the on-die memory.

18. The method of claim 17, wherein the ISP circuit, the DPU circuit, and the on-die memory are implemented on a single die.

19. The method of claim 17, wherein the processing the image data output from the ISP circuit through the second portion of the VST pipeline circuit comprises:
generating, by the DPU circuit, blended image data by blending image data output from the ISP circuit with image data specifying one or more digital content items generated by a Graphics Processing Unit (GPU).

20. The method of claim 17, wherein the plurality of hardened circuit blocks of at least one of the ISP circuit or the DPU circuit are coupled by a multiplexer circuit, the method further comprising:
bypassing one or more selected hardened circuit blocks of the plurality of hardened circuit blocks responsive to control signals provided to the multiplexer circuit.
